(19) United States
(12) Patent Application Publication
(10) Pub. No.: US 2016/0235082 A1
(43) Pub. Date: Aug. 18, 2016

(54) HEAT STABLE WHEY PROTEIN PRODUCTS AND A PROCESS FOR THE PREPARATION OF HEAT STABLE WHEY PROTEINS

(71) Applicant: South Dakota State University, Brookings, SD (US)

(72) Inventors: Hasmukh Ambalal PATEL, Plymouth, MN (US); Suresh Ganpatbhai SUTARIYA, Le Mars, IA (US)

(21) Appl. No.: 15/046,034

(22) Filed: Feb. 17, 2016

Related U.S. Application Data
(60) Provisional application No. 62/116,951, filed on Feb. 17, 2015.

(51) Int. Cl. A23C 3/08; A23C 21/00; A23J 3/08; A23C 3/033

(52) U.S. Cl. CPC A23C 3/085; A23C 3/033; A23C 21/00; A23J 3/08

(57) ABSTRACT

Different versions of heat stable whey protein ingredients can be produced by subjecting whey protein solutions to specific heat treatments in the presence of a specific concentration of hydrogen peroxide. The whey protein ingredients including heat stable liquid retentate of WPI, WPC or any other form of whey protein ingredients, and heat stable powders of WPI or WPC or any other whey protein powders can be prepared by heat treatment of a whey protein solution mixed with a hydrogen peroxide solution. The heat stable whey proteins have the starting whey protein cystine converted to cystine sulfonic acid, such that the free sulfhydral groups of major whey protein (β-lactoglobulin) being converted into non-reactive compounds, such as cysteine sulphonic acid and/or cysteic acid, which not only minimizes or eliminates undesirable gelling but also is a precursor for taurine group of compounds.

### RELATED APPLICATION

The present application claims the benefit of U.S. Provisional Application No. 62/116,951, filed Feb. 17, 2015, which is hereby incorporated herein in its entirety by reference.

### TECHNICAL FIELD

The present invention relates to whey protein products and methods for making such products. More particularly, the present invention relates to heat stable whey protein products and methods for making such heat stable whey proteins, even more particularly whey proteins subjected to specific heat treatments in the presence of certain concentrations of hydrogen peroxide.

### BACKGROUND

Whey protein is considered as high quality protein because of its branch chain amino acid. Growing awareness about the nutritional benefits of whey proteins and technological advancements in improving functional properties has led to ever increasing demand of whey proteins in form of commercial whey protein ingredients such as whey protein concentrates (WPC) and whey protein isolates (WPI). These ingredients have Generally Regarded As Safe (GRAS) status and are widely used in a variety of products such as whey protein fortified sports beverages, nutritional and meal replacement beverages. In most case, these beverage products are subjected to severe heat treatments such as temperatures of about 120° C. for about 15-20 minutes (retort sterilization) or temperatures of about 140° C. for about 3-4 seconds (UHT treatment) for food safety reasons and to extend their shelf-life. However, the heat treatment of whey protein solutions above 85° C. leads to denaturation and aggregation of whey proteins; and at sufficiently high protein concentration (typically beyond 8-10% proteins content), whey proteins tend to form heat-induced gels. Because of their poor heat stability, whey proteins show precipitation, aggregation, sedimentation or gelation of whey protein in the beverages, particularly if the beverages are subjected to severe heat treatment such as retort or UHT treatment. While aggregation and gelation is desirable in the application of whey proteins in many products such as bakery, meat, pudding or sauces, such aggregation, gelation, precipitation or thickening is considered highly undesirable for incorporation of whey proteins in high protein beverages and for processing of liquid food products.

In recent years, consumer demand for whey protein fortified nutritional, meal replacement beverages containing high protein (preferably more than 10% protein) is increasing. To be able to formulate heat-stable, high protein beverages having a long shelf-life, it is important to ensure that the whey protein used in such high protein beverage formulations are heat stable. Various approaches have been used to improve the heat stability of whey proteins, and extensive literature is available on this topic. Some examples of approaches to improve heat stability of whey proteins include, tailoring protein-carbohydrate interactions (Rich and Foegeding, 2000, Foegeding et al., 2002, Baier and McClements, 2005), the treatment with glycerol (Kulmyrzaev et al., 2000, Rich and Foegeding, 2000), the application of transglutaminase (Tanimoto and Kinsella, 1988, Zhang and Zhong, 2009), partial enzymatic hydrolysis of whey proteins (Doucet and Foegeding, 2005), using high pressure processing (Patel et al., 2005) or combination of high pressure and binding ligands to whey proteins (Considine et al., 2005a, Considine et al., 2005b, Considine et al., 2007a, Considine et al., 2007b), the use of milk protein concentrate as a chaperone agent (Zhang et al., 2005, Yong and Foegeding, 2008) and treatment of WPI solutions with combination of enzymatic hydrolysis and succinic anhydride induced electrostatic repulsion (Yilmaz-Gemili, 2012), application of stabilizing and calcium cheating agent such as sodium phosphate and EDTA (Kuhn and Foegeding, 1991, Xiong, 1992), ultrasonication of whey proteins (Zisu et al., 2010), tailored polysaccharide-whey protein interactions (Zhang et al., 2004), formation of protein-soluble-aggregates (Ryan et al., 2012) and blocking free —SH groups by use of various chemicals such as N-ethylmaleimide, mercaptoethanol, iodoacetamide, lipoic acid and dihydrolipoic acid interfere in sulfhydryl-disulfide interchange reaction and improved heat stability of whey proteins (Sawyer, 1968, Iametti et al., 1996, Wijayanti et al., 2013). However, limited success has been achieved to date.

Hydrogen peroxide (H₂O₂) has a GRAS status. It is permitted for use by the Code for Federal Regulation (CFR, 2014b) under 21 CFR 184.1366 to use at a maximum allowed concentration for the various purposes such as: antimicrobial agent in the starch and in the milk intended for use during the cheese making process (500 ppm), for bleaching of whey (up to 400 ppm) as well as a bleaching agent in beef, tripe, instant tea and whey (500 ppm), an oxidizing and reducing agent in corn syrup, dried eggs and wine (21 CFR 184.1366). It is also allowed for use in washing or to assist in the peeling of fruits and vegetables (21 CFR 173.315) as well as a sterilizing agent for food packaging materials.

H₂O₂ is a strong oxidizing agent. Many reports in the literature suggested use of H₂O₂ in the dairy industry for various purposes. For example, H₂O₂ has been used as a preservative in milk (Williams, 1966; Mistry & Kosikowski, 1985), bleaching agent for whey (Croissant et al., 2009; Jervis & Drake, 2013), and in milk for cheese making (Roundy, 1958; Kosikowski & Fox, 1968). Some reports are available on the effect of H₂O₂ on sensory and functional properties of WPC (Jervis et al., 2012). However, no application of H₂O₂ has been reported for improving heat stability of whey protein, as well as manufacturing WPC and WPI with improved heat stability.

Accordingly, there is a need in the industry for improved whey proteins with improved functionality and nutrition, including heat stable whey proteins, either in liquid or dried form. There is also a need in the industry for improved manufacturing processes of such heat stable whey proteins and whey protein ingredients.

### SUMMARY

The present invention is directed to a process for the preparation of heat stable whey proteins, either in liquid or dried form, by optimizing specific combinations of hydrogen peroxide and heat treatment at specific stages during the manufacturing process of whey protein ingredients. In this process, hydrogen peroxide can be added as a processing aid, which plays a specific role in altering the intermolecular sulfhydryl-disulfide interchange reaction responsible for heat-induced aggregation and gelation of whey proteins. The process of the present invention by which heat stable intermediate compounds can be formed at sufficiently higher protein concentration does not form precipitate or gel when whey protein solutions are subjected to severe heat treatments, such as the case with retort or UHT. Instead, these high temperature conditions can be tolerated by the whey proteins to make them heat stable according to certain aspects of the present invention.

The present invention is also directed to at least two different versions of heat stable whey protein ingredients (1) heat stable liquid retentate of WPI, WPC or any other form of whey protein ingredients and (2) heat stable powder WPI, WPC or other whey protein powders. According to certain aspects of the present invention, the heat stable liquid retentate of WPI, WPC or any other form of whey protein ingredients are formed according to the process of the present invention. According to certain aspects of the present invention, the heat stable powder WPI, WPC or any other whey protein powders are formed according to the process of the present invention.

In certain aspects of the present invention, whey is provided, which may be stored in a storage tank, to a series of ultra filtration and/or micro filtration steps to separate and/or concentrate the whey proteins. According to certain aspects of the present invention, hydrogen peroxide is added in a suitable amount of water to make a hydrogen peroxide solution having a desired concentration. The whey solution and hydrogen peroxide solution are combined in a mixing or reaction tank, such that the hydrogen peroxide reacts with the whey protein. In certain aspects of the present invention, the whey solution and hydrogen peroxide solution are mixed in a reaction tank, such that the hydrogen peroxide reacts with the whey protein. The mixture of the whey protein solution treated with the hydrogen peroxide solution undergoes a pasteurization process at a desired temperature for a desired period of time to form a heat stable solution or liquid retentate of WPI, WPC or other whey protein ingredients. In certain aspects, an excess amount of hydrogen peroxide may be removed. The resultant whey protein solution may undergo ultra-filtration to remove excess lactose. The whey protein solution may also undergo an evaporation step to concentrate the whey protein to a desired whey protein concentration. In certain aspects, the whey protein solution may be dried to form a powder.

In certain aspects of the present invention, the heat stable solutions or liquid retentate of WPI, WPC or other whey protein ingredients can be prepared by subjecting the reaction mixture containing whey protein to specific heat treatments in the presence of a specific amount of hydrogen peroxide during specific stages of the manufacturing process.

In certain other aspects of the present invention, the liquid retentate of WPI, WPC or other whey protein ingredients can be prepared by subjecting the reaction mixture containing whey protein and hydrogen peroxide to a non-thermal method that normal denatures proteins, including high pressure processing, pulsed electric field, or the like, with the presence of a specific amount of hydrogen peroxide being in the range of about 300 ppm to about 500 ppm.

In certain aspects, the heat stable solutions or liquid retentate of WPI, WPC or other whey protein ingredients can be prepared by subjecting the reaction mixture of whey protein and hydrogen peroxide to specific heat treatments at temperatures in the range of about 60° C. to about 200° C. for about 5 seconds or longer in the presence of a specific amount of hydrogen peroxide in the range of about 300 ppm to about 500 ppm.

In certain other aspects, the specific heat treatment of the whey protein solution and hydrogen peroxide solution reaction mixture is at a temperature of about 60° C. to about 200° C., in other aspects about 70° C. to about 180° C., in other aspects about 80° C. to about 160° C., and in other aspects about 85° C. to about 145° C.

In certain other aspects, the specific heat treatment of the whey protein solution and hydrogen peroxide solution reaction mixture for about 1 second to about 25 minutes, in some other aspects about 5 seconds to about 20 minutes, in some other aspects about 15 seconds to about 18 minutes, and in some other aspects about 1 minute to about 10 minutes.

In certain other aspects, the hydrogen peroxide concentration is about 300 ppm to about 500 ppm, in some other aspects about 325 ppm to about 480 ppm, in some other aspects about 340 ppm to about 470 ppm, in some other aspects about 350 ppm to about 450 ppm, and in some other aspects about 375 ppm to about 425 ppm.

In certain aspects, after the specific heat treatment in the presence of hydrogen peroxide, the excess residual hydrogen peroxide can then be removed by methods such as catalase treatment, ultraviolet (UV) light; electrochemical reduction and oxidation, activated carbon catalysts, a pyrolusite catalyst or any other method or chemicals which can break the hydrogen peroxide into water and oxygen molecules or any other molecules.

In certain aspect of the present invention, after the removal of excess hydrogen peroxide the treated solutions can then be concentrated by ultra-filtration to obtain a heat-stable concentrated liquid or retentate of WPI, WPC or any other whey protein ingredients containing about 6% protein or higher. In certain aspect of the present invention, after the removal of excess hydrogen peroxide the treated solutions can then be concentrated by ultra-filtration to obtain a heat-stable concentrated liquid or retentate of WPI, WPC or any other whey protein ingredients containing about 6% protein to about 20% protein, in some aspects about 8% protein to about 18% protein, and in some other aspects about 10% protein to about 16% protein.

In certain aspects of the present invention, the concentrated forms of liquid or retentate of WPI or WPC can be dried to obtain a heat-stable powder of WPI, WPC or any other whey proteins ingredients. In certain aspects of the present invention, the liquid or retentate of WPI or WPC can be freeze dried to obtain a heat stable WPI powder, WPC powder or whey protein powder.

In certain aspects of the present invention, during the heat treatment of a solution containing whey proteins in the presence of a sufficient concentration of hydrogen peroxide, one or more of the free sulfhydral groups of major whey protein (β-lactoglobulin) are converted into non-reactive compounds (e.g. cystine sulfonic acid), which is a precursor for taurine group of compounds. Taurine is generally used in the energy drinks and is regarded as non-harmful for human consumption. In certain aspects, the cystine of the starting whey protein product is converted to essentially a non-reactive compound, such as cystine sulfonic acid in the resulting heat stable whey proteins.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a flow diagram for the typical preparation of WPI powder.

FIG. 2 is a flow diagram for the preparation of whey protein solutions and whey protein powders according to certain aspects of the present invention.

FIG. 3 is a photograph detailing a heat stability test at 121° C. for 20 minutes for WPI solution (13% protein w/v) treated with varying concentration of hydrogen peroxide, wherein (A) Control sample—no hydrogen peroxide added, (B) 20 ppm hydrogen peroxide added, and (C) 400 ppm hydrogen peroxide. The figure clearly indicates that sample A and sample B had a poor heat stability formed gel, whereas sample C (which was treated with sufficient quantity of H₂O₂) was heat stable and did not form a gel.

FIG. 4 is a graph generated from rheological measurements showing the change in shear storage modulus G′ during gel formation of solutions containing whey protein isolates (13% protein w/v) with hydrogen peroxide concentrations (ppm): 0 (⋄), 20 (Δ), 400 (□). The straight line indicates the temperature profile where samples were heated from 30° C. to 90° C. at 2° C. min per minute and held for 10 min, then cooled to 20° C. at the same scan rate and held for 10 min. Storage modulus (G′) is the measure of the firmness of gels. The results presented clearly indicate that samples without the hydrogen peroxide concentration according to certain aspects of the present invention formed a gel with higher storage G′ compared to that of sample having a sufficient quantity of H₂O₂. These results confirm that the sample having sufficient quantity of H₂O₂ remained liquid, whereas those without a sufficient quantity of H₂O₂ produced a firm gel.

FIG. 5 is a photograph detailing a heat stability test at 120° C. for 3 minutes for WPI samples treated with varying concentration of hydrogen peroxide, wherein (A) Control sample—no hydrogen peroxide, (B) 20 ppm hydrogen peroxide, and (C) 400 ppm hydrogen peroxide. The figure clearly indicates that sample A and sample B had a poor heat stability formed gel, whereas sample C (which was treated with sufficient quantity of H₂O₂) was heat stable and did not form a gel.

FIG. 6 is a photograph detailing a heat stability test at 140° C. for 3 minutes for WPI samples treated with varying concentration of hydrogen peroxide, wherein (A) Control sample—no hydrogen peroxide, (B) 20 ppm hydrogen peroxide, and (C) 400 ppm hydrogen peroxide. The figure clearly indicates that sample A and sample B had a poor heat stability formed gel, whereas sample C (which was treated with sufficient quantity of H₂O₂) was heat stable and did not form a gel.

FIG. 7 is an SDS-PAGE (non-reducing) electrophoresis pattern of heated (120° C./1 min) WPI solution (4% w/v protein). Lane 1 standard molecular weight marker; lane 2=heated control sample (without addition of hydrogen peroxide); WPI samples containing different concentration of hydrogen peroxide (ppm); lane 3=20 ppm; lane 4=400 ppm; lane 5=Non-heated control, wherein Ig=Immunoglobulins, BSA=Bovine serum albumin, β-Lg=β-Lactoglobulin, and α-Lg=α-Lactoalbumin.

FIG. 8 is a graph showing percent disulfide induced denatured α-La and β-Lg as determined by SDS-PAGE (Non-reduced) method. Percentage of protein denaturation was determined by comparing the intensity of bands (FIG. 7) corresponding to β-LG and α-LA in the heat-treated control and test (containing H₂O₂) samples in comparison to that in non-heated control sample. The SDS-PAGE results suggest that the heat treated control sample (without H₂O₂) had the highest percentage of denaturation (mainly disulfide induced denaturation of β-LG and α-LA, up to ˜80%). Compared to the heated control samples, the level of denaturation and disulfide-linked aggregation of β-LG and α-LA decreased with increased 400 ppm level of H₂O₂ (HTPR) in the WPI solution samples.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

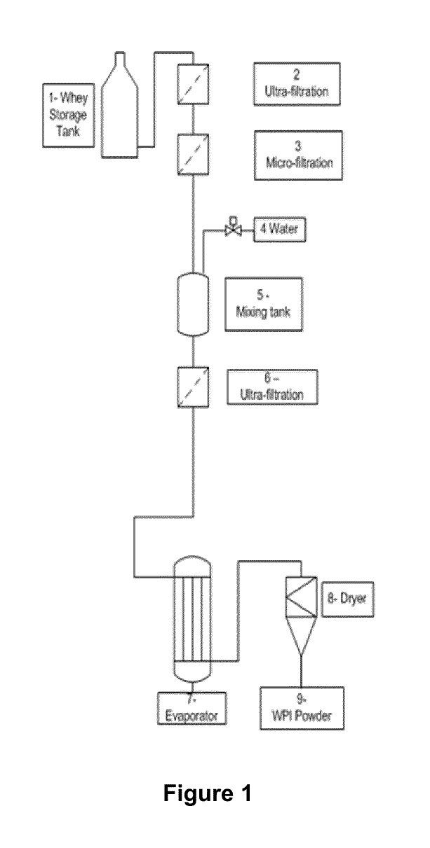

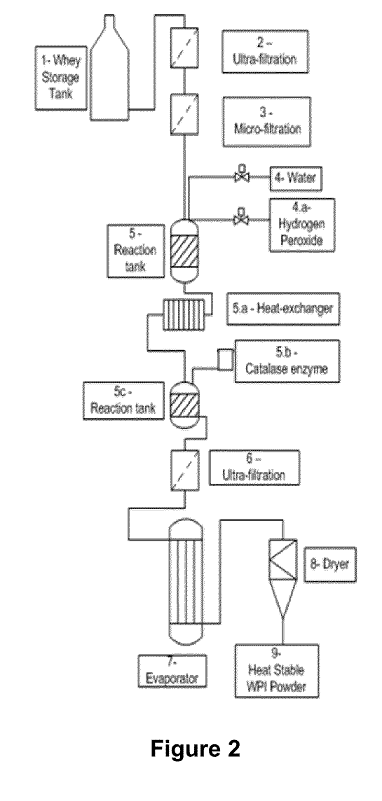

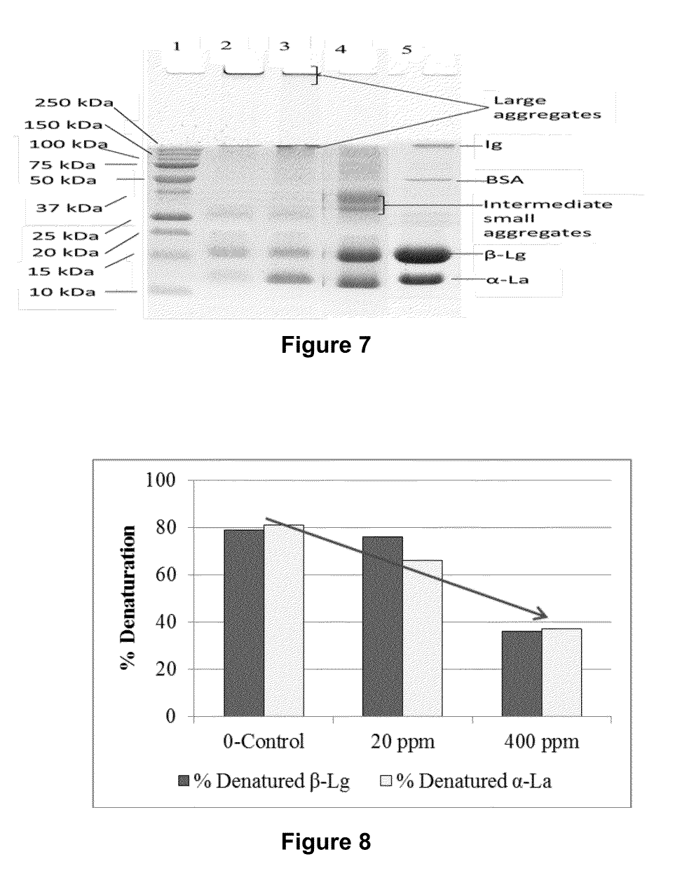

The method of the present invention can produce at least two different versions of heat stable whey protein ingredients. For example, the method according to certain aspects of the present invention can make (1) heat stable liquid retentate of WPI, WPC or any other form of whey protein ingredients, and (2) heat stable WPI, WPC or other whey protein powders. The inventive method (FIG. 2) is an improvement over conventional WPI preparation methods (FIG. 1) and various analytical methods including heat stability test and rheological analysis clearly demonstrate that the WPI made using the process according to certain aspects of the present invention were more heat stable. Sodium dodecyl Sulfate polyacrylamide gel electrophoresis (SDS-PAGE) analysis (FIG. 7) also supported these results.

The present invention involves preparation of heat stable whey proteins by subjecting the dilute whey protein solutions to heat treatment in the presence of hydrogen peroxide. Referring generally to FIG. 2, whey, which may be stored in a storage tank 1, may undergo a filtration step or a series of ultra filtration and/or micro filtration steps 2, 3 to separate and/or concentrate the whey proteins. After the desired concentration of whey protein is achieved, the whey protein may be provided in a reaction tank 5. A desired concentration of hydrogen peroxide may also be provided in the reaction tank 5. In some aspects, a source of hydrogen peroxide 4a may be added to the reaction tank with a suitable amount of water 4 to provide a hydrogen peroxide solution having a desired concentration in the reaction tank 5 with the whey protein. The whey solution and hydrogen peroxide solution may be combined in the reaction tank and mixed, such that the hydrogen peroxide reacts with the whey protein. The mixture of the whey protein solution treated with the hydrogen peroxide solution undergoes a pasteurization process at a desired temperature for a desired period of time to form a heat stable solution or liquid retentate of WPI, WPC or other whey protein ingredients. In certain aspects, the pasteurization process occurs via a heat-exchanger 5a. Upon the heating of the whey protein/hydrogen peroxide mixture, an excess amount of hydrogen peroxide may be removed. As shown in FIG. 2, the excess amount of hydrogen peroxide is removed via catalase enzyme processing in a reaction tank 5c by adding catalase enzyme 5b to the previously heated whey protein/hydrogen peroxide mixture. The resultant whey protein solution may undergo a filtration step, such as ultra-filtration 6 to remove excess lactose. The whey protein solution may also undergo an evaporation step 7 to concentrate the whey protein to a desired whey protein concentration. In certain aspects, the whey protein solution may be dried 8 to form a heat stable whey protein powder 9.

In certain aspects of the present invention, the heat stable solutions or liquid retentate of WPI, WPC or other whey protein ingredients can be prepared by subjecting the reaction mixture containing whey protein to specific heat treatments in the presence of a specific amount of hydrogen peroxide during specific stages of the manufacturing process.

In certain aspects, the heat stable solutions or liquid retentate of WPI, WPC or other whey protein ingredients can be prepared by subjecting the reaction mixture of whey protein and hydrogen peroxide to specific heat treatments at temperatures in the range of about 60° C. to about 200° C. for about 60 seconds or longer in the presence of a specific amount of hydrogen peroxide in the range of about 300 ppm to about 500 ppm.

In certain other aspects, the specific heat treatment of the whey protein solution and hydrogen peroxide solution reaction mixture is at a temperature of about 60° C. to about 200° C., in other aspects about 70° C. to about 180° C., in other aspects about 80° C. to about 160° C., and in other aspects about 85° C. to about 145° C.

In certain other aspects, the specific heat treatment of the whey protein solution and hydrogen peroxide solution reaction mixture for about 60 seconds to about 25 minutes, in some other aspects about 60 seconds to about 20 minutes, in some other aspects about 60 seconds to about 10 minutes.

In certain other aspects, the hydrogen peroxide concentration is about 300 ppm to about 500 ppm, in some other aspects about 325 ppm to about 480 ppm, in some other aspects about 340 ppm to about 470 ppm, in some other aspects about 350 ppm to about 450 ppm, and in some other aspects about 375 ppm to about 425 ppm.

In certain aspects, after the specific heat treatment in the presence of hydrogen peroxide, the excess residual hydrogen peroxide can then be removed by methods such as catalase treatment, ultraviolet (UV) light; electrochemical reduction and oxidation, activated carbon catalysts, a pyrolusite catalyst or any other method or chemicals which can break the hydrogen peroxide into water and oxygen molecules or any other molecules.

In certain aspect of the present invention, after the removal of excess hydrogen peroxide the treated solutions can then be concentrated by ultra-filtration to obtain a heat-stable concentrated liquid or retentate of WPI, WPC or any other whey protein ingredients containing about 6% protein or higher. In certain aspect of the present invention, after the removal of excess hydrogen peroxide the treated solutions can then be concentrated by ultra-filtration to obtain a heat-stable concentrated liquid or retentate of WPI, WPC or any other whey protein ingredients containing about 6% protein to about 20% protein, in some aspects about 8% protein to about 18% protein, and in some other aspects about 10% protein to about 16% protein.

In certain aspects of the present invention, the concentrated forms of liquid or retentate of WPI or WPC can be dried to obtain a heat-stable powder of WPI, WPC or any other whey proteins ingredients. In certain aspects of the present invention, the liquid or retentate of WPI or WPC can be freeze dried to obtain a heat stable WPI powder, WPC powder or whey protein powder.

In certain aspects of the present invention, during the heat treatment of a solution containing whey proteins in the presence of a sufficient concentration of hydrogen peroxide, one or more of the free sulfhydral groups of major whey protein (β-lactoglobulin) are converted into non-reactive compounds (e.g. cystine sulfonic acid), which is a precursor for taurine group of compounds. Taurine is generally used in the energy drinks and is regarded as non-harmful for human consumption. As such, in certain aspects of the present invention, the cystine of the starting whey protein product is converted to essentially a non-reactive compound, such as cystine sulfonic acid in the heat stable whey protein.

It has been known in the art that β-lactoglobulin contains two free-SH (Cys) in its structure. These free —SH groups are highly reactive. Upon heat treatment, these free —SH reacts with other —SH groups in the structure of the protein and forms disulfide-linked aggregation, and at sufficiently higher concentration of proteins (e.g. >7-8% protein), it forms gel. Therefore, this free, reactive —SH is believed to be mainly responsible for inducing the chain reaction leading to denaturation and inter and intra-molecular disulphide-linked aggregation.

In the present inventive process, it is believed that hydrogen peroxide plays a specific role in altering the intra- and intermolecular sulfhydryl-disulfide interchange reaction responsible for heat-induced aggregation and gelation of whey proteins by binding with free —SH group and converting it to non-reactive intermediate compounds such as Cysteic Acid and Cysteine Sulphonic acid. The process of the present invention, which forms heat stable intermediate compounds, does not form precipitate or gel when whey protein solutions are subjected to severe heat treatments such as retort or UHT at sufficiently higher protein concentrations; but instead, these conditions can be tolerated by the whey proteins to make them heat stable.

During the heat treatment of solution containing whey proteins in the presence of a sufficient concentration of hydrogen peroxide according to certain aspects of the present invention, the free sulfhydral group of major whey protein (β-lactoglobulin) are converted into non-reactive compounds cysteic acid and/or cysteine sulphonic acid, which is a precursor for taurine group of compounds. Taurine is generally used in the energy drinks and is regarded as non-harmful for human consumption. In this process, significant quantity of Free-SH group at least 60%, in some aspects at least 70%, and in some other aspects at least 80% is converted to nonreactive compound such as Cysteic acid/Cysteine Sulphonic Acid form. This process mainly alters the free-SH group; therefore the inventors without wishing to be bound to theory believe that only free —SH groups take part in this reaction. Typical whey protein isolate powder contains about 2400 to 2600 mg of cysteine/100 gm protein. Whereas WPI used in the present study have a calculated concentration of Taurine like compound or taurine precursor being around 350 mg/100 gm protein (2500*0.14=350 mg).

The present invention involves preparation of heat stable whey proteins by subjecting the dilute whey protein solutions to heat treatment in the presence of hydrogen peroxide. The whey protein solutions in the range of about 0.05% to about 20.0% protein content, in certain other aspects in the range of about 1% to about 16% protein content, while a heat treatment can be in the range of about 72° C. to about 145° C. for about 1 second to about 1200 seconds or higher in the presence of hydrogen peroxide in the concentration range of about 100 ppm to about 1000 ppm, in certain other aspects in the range of about 300 to about 400 ppm.

The excess residual hydrogen peroxide can then be removed by any conventional method such as the treatment with a catalase enzyme. The resulting heat stable whey protein solution can be concentrated by any known means such as ultra-filtration or evaporation to obtain a heat stable liquid WPI concentrate with up to at least 6% protein, in some aspects up to about 20% protein, in certain other aspects up to about 20% protein, and in some further aspects between about 18% and about 20% protein. Additionally, the stable liquid WPI, WPC or any other liquid, solutions or beverages containing whey proteins can be converted into a dried form, such as a powder, by any drying techniques, such as freeze drying, spray drying or any other drying methods known in the art to obtain a heat stable WPI, WPC or any other form of whey protein. In certain aspects, the WPI, WPC or any other form of heat stable whey proteins are in the form of a dried powder ingredients.

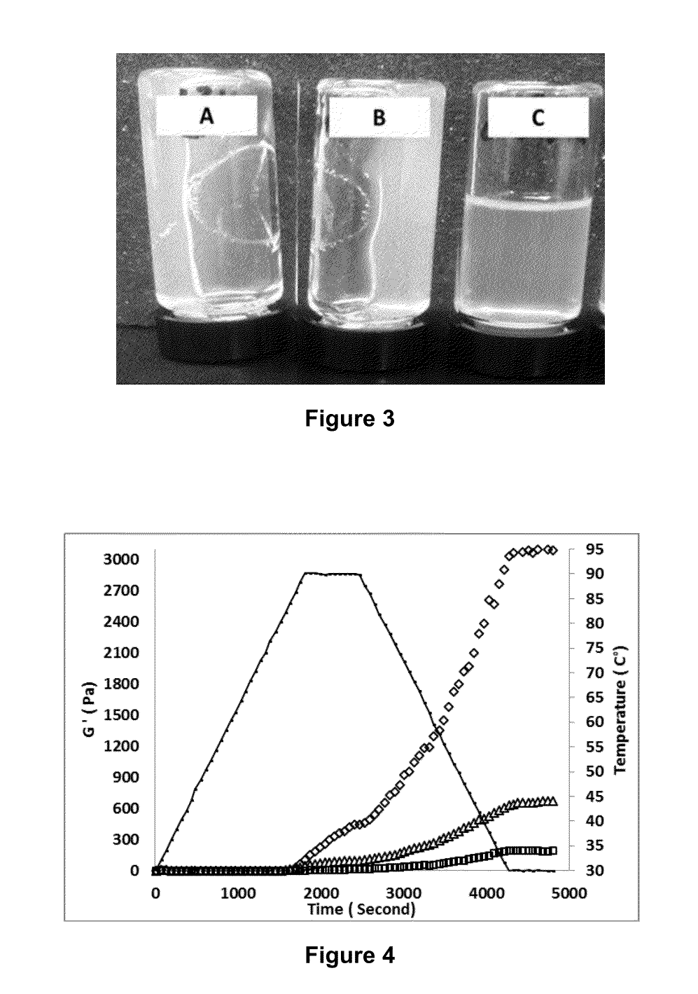

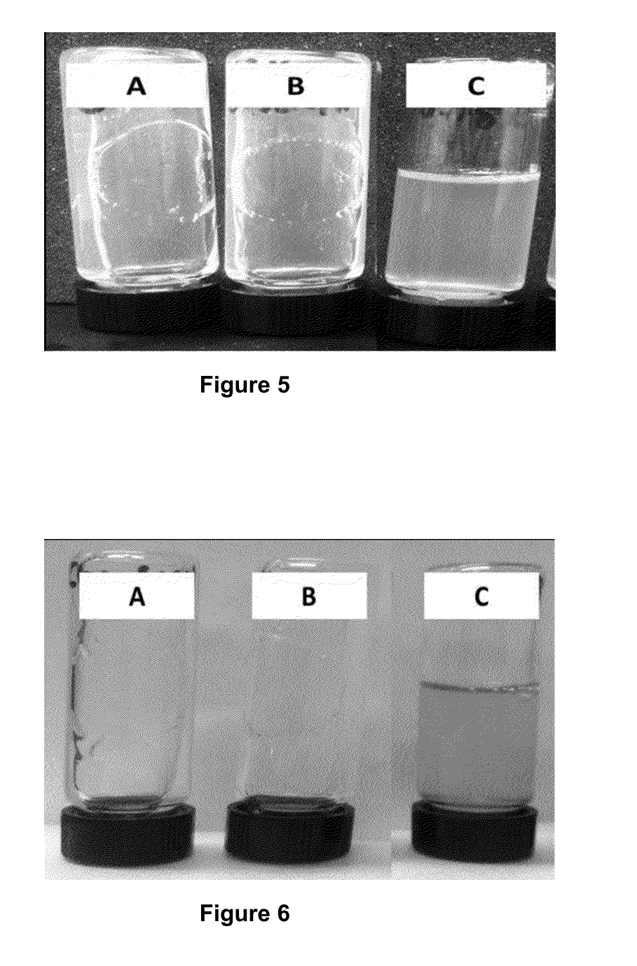

Heat stability tests have been performed on the whey protein solutions at 121° C. for 20 minute for the samples treated with varying concentration of hydrogen peroxide, including a WPI sample treated with a hydrogen peroxide concentration according to certain aspects of the present invention. Referring now to FIG. 3, which details the results where (A) is the Control sample—no hydrogen peroxide, (B) added with 20 ppm hydrogen peroxide, and (C) added with 400 ppm hydrogen peroxide. As shown from the results presented in FIG. 3, the sample treated with 400 ppm of H₂O₂ (sample C) remained liquid after severe heat treatment in comparison to samples A (control), suggesting that the sample C (made using the present inventive method) was more heat stable. Storage modulus (G′) is the measure of the firmness of gels. The results presented in FIG. 4 shows that the control samples with no treatment produced very rigid gels, whereas the samples treated with H₂O₂ did not form gel network and remain liquid after heat treatment. These results confirmed the results presented in FIG. 3. Similar results as observed in FIG. 3 were also found when WPI retentate (12-15% protein concentration) with and without treatment with H₂O₂ were subjected to severe heat treatment such as 120° C. for 3 min (FIG. 5) or 140° C. for 3 min (FIG. 6). To determine the effect of hydrogen peroxide treatment on reduction in disulfide linked aggregation, WPI solutions containing 4% protein and different levels of hydrogen peroxide (as in FIG. 6) were preheated at 120° C. for 1 min., the samples were analyzed using SDS-PAGE under non reducing condition. The results are presented in FIG. 7 and FIG. 8. The examples showed that the process of heating whey proteins in the presence of specific amount of hydrogen peroxide during the specific steps of manufacturing led to improvement of heat stability and heat-induced gelation of whey proteins by preventing or minimizing the denaturation of whey proteins through alteration of the pathways related to intermolecular disulfide interactions of whey protein denaturation, aggregation and gelation, which can play a significant role in improving the heat-stability of WPI solutions. The present invention presents the possibility of increasing the protein content in food and beverage products such as whey protein based sports, nutritional beverages and meal replacement beverages, where poor heat stability of whey protein is a limiting factor.

### Analytic Methods:

### Heat Coagulation Time Test:

The heat coagulation time test was performed at 120° C. and 140° C. using an oil bath. 5 ml of WPI (12.8% protein) samples were filled in 8 mL wheaton glass tube (D-17 mm×H-61 mm) and submerged in an oil bath (on rotating platform operating at medium speed) maintained at 120° C. and 140° C. Heat coagulation time (HCT) was defined as the time required for forming visible set precipitation or coagulation or gelling at 120° C. and 140° C.

### Rheological Measurement:

A dynamic oscillatory shear test was performed in a controlled stress rheometer (STRESSTECH ATS, Bordentown, N.J.) fitted with a bob and cup geometry (25 mm diameter, gap 1 mm). A peltier system in the bottom plate enabled fast and accurate temperature control. 15 ml of sample used for analysis and sample surface was covered with a thin layer of paraffin oil at the start of the test, in order to prevent evaporation.

Each sample was pre-sheared and equilibrated for 5 min followed by a temperature ramp from 30° C. to 90° C., at a rate of 2° C./min, after which the temperature was maintained at 90° C. for 10 min. At the end of this time sweep, the sample was cooled down to 30° C. at a rate of 2° C./min, and the temperature was maintained at 30° C. for 10 min. A maximum shear strain of 0.5% and a frequency of 1 Hz were used for the temperature-time sweep. A strain sweep from 0.1 to 1% was then made to verify that the product temperature-time sweep was conducted within the linear viscoelastic region. From this method G′ (elastic modulus) values were obtained to compare the elasticity difference (gel strength) between control and test samples.

### Sodium Dodecyl Sulfate-Polyacrylamide Gel Electrophoresis (SDS-PAGE):

WPI solutions containing 4% protein and different levels of H₂O₂ were preheated at 120° C. for 2 min. WPI samples were analyzed using SDS-PAGE under non reducing condition as described by Tovar Jimenez and Rosario (2012) with slight modifications. The electrode buffer (pH 8.3) contained 0.025 M Tris-Base, 0.192 M glycine and 0.1% SDS. The WPI samples were diluted in the SDS sample buffer containing 62.5 mM Tris-HCl (pH 6.8), 10% glycerol, 2% SDS and 0.01% (W/v) bromophenol blue. An aliquot of each sample containing 0.015 mg protein and 10 μl of MW standards were loaded into each well. The samples were electrophoresed at voltage 200 V for 55 min. After electrophoresis gels were removed from slabs and stained for 1 hour using 0.1% (w/v) amido black 10B in 10% (v/v) acetic acid and 25% (v/v) 2-propanol. After staining the gels, they were de-stained using 10% acetic acid (v/v) solution for a total of 18 hours with 2 destaining. The stained gels were then photographed using a Bio-5000 Microtek scanner (Hsinchu, Taiwan) and the images were analyzed using the Bio image Intelligent Quantifier v 3.3.7 system (Jackson, Mich.) to quantify the intensity of whey protein bands.

These terms and specifications, including the examples, serve to describe the invention by example and not to limit the invention. It is expected that others will perceive differences, which, while differing from the forgoing, do not depart from the scope of the invention herein described and claimed. In particular, any of the function elements described herein may be replaced by any other known element having an equivalent function.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. §112(f) are not to be invoked unless the specific terms “means for” or “step for” are recited in a claim.

1. A method for the preparation of heat stable whey proteins, the method comprising:
providing a whey protein solution in a reactor vessel with a hydrogen peroxide solution;
heating the whey protein solution in the presence of the hydrogen peroxide solution to a temperature between about 60° C. to about 200° C.; and
removing any excess residual hydrogen peroxide after the heating step to provide a heat stable whey protein solution.

2. The method of claim 1, further comprising reacting the whey protein solution in the presence of the hydrogen peroxide.

3. The method of claim 1, further comprising providing a source of whey that undergoes a filtration process to provide the whey protein solution having a desired concentration.

4. The method of claim 3, wherein the source of whey is stored in a storage tank.

5. The method of claim 3, wherein the filtration process comprises at least one of ultra filtration and micro filtration.

6. The method of claim 1, wherein the hydrogen peroxide solution has a concentration of about 300 ppm to about 500 ppm.

7. The method of claim 1, further comprising filtering the heat stable whey protein solution to provide a filtered heat stable whey protein solution.

8. The method of claim 7, further comprising evaporation of liquid from the filtered heat stable whey protein solution to form a concentrated heat stable whey protein solution.

9. The method of claim 8, further comprising drying the concentrated heat stable whey protein solution to form a heat stable whey protein powder.

10. The method of claim 9, wherein the whey protein powder is a whey protein concentrate or a whey protein isolate.

11. The method of claim 1, wherein the excess residual hydrogen peroxide can be removed by a method chosen from the group consisting of catalase treatment, ultraviolet light, electrochemical reduction and oxidation, activated carbon catalysts, and pyrolusite catalyst.

12. The method of claim 1, wherein heating the whey protein solution in the presence of the hydrogen peroxide solution occurs at a temperature between about 85° C. to about 145° C.

13. The method of claim 12, wherein heating the whey protein solution in the presence of the hydrogen peroxide solution occurs for about 3 seconds to about 25 minutes.

14. The method of claim 1, wherein the hydrogen peroxide solution has a concentration between about 300 ppm to about 500 ppm.

15. The method of claim 1, wherein heat stable whey protein solution contains about 6% protein to about 20% protein.

16. The method of claim 1, wherein at least a portion of the cystine in the whey protein solution is converted to a taurine group precursor in the heat stable whey protein solution.

17. A method for the preparation of heat stable whey proteins, the method comprising:
providing a whey protein solution in a reactor vessel with a hydrogen peroxide solution having a concentration between about 300 ppm to about 500 ppm;
heating the whey protein solution in the presence of the hydrogen peroxide solution to a temperature between about 60° C. to about 200° C. for a period of time of at least about 3 seconds;
removing any excess residual hydrogen peroxide after the heating step to provide a heat stable whey protein solution; and
processing the heat stable whey protein solution to provide a concentrated heat stable whey protein solution.

18. The method of claim 17, wherein the processing comprises filtering the heat stable whey protein solution to provide a filtered heat stable whey protein solution and evaporation of liquid from the filtered heat stable whey protein solution to form a concentrated heat stable whey protein solution.

19. The method of claim 18, further comprising drying the concentrated heat stable whey protein solution to form a whey protein powder.

20. A heat stable whey protein prepared by the process comprising:
heating a whey protein solution in the presence of a hydrogen peroxide solution in a reactor vessel at a temperature between about 60° C. to about 200° C. for a period of time of at least about 3 seconds, the hydrogen peroxide solution having a concentration between about 300 ppm to about 500 ppm;
removing any excess residual hydrogen peroxide after the heating step to provide a heat stable whey protein solution; and
processing the heat stable whey protein solution to provide a concentrated heat stable whey protein;
wherein concentrated heat stable whey protein comprises a taurine precursor provided by converting at least a portion of the cystine in the whey protein solution to the taurine precursor during the heating step in the presence of the hydrogen peroxide solution.
